(19) United States
(12) Patent Application Publication
(10) Pub. No.: US 2013/0155113 A1
(43) Pub. Date: Jun. 20, 2013

(54) IMAGE DISPLAY DEVICE AND MOBILE DEVICE

(71) Applicant: SANYO ELECTRIC CO., LTD., Moriguchi-city (JP)

(72) Inventors: Kazunori KOTANI, Nara-city (JP); Hisashi NAKAMURA, Kobe-city (JP)

(73) Assignee: SANYO ELECTRIC CO., LTD., Moriguchi-city (JP)

(21) Appl. No.: 13/715,406

(22) Filed: Dec. 14, 2012

(30) Foreign Application Priority Data
Dec. 15, 2011 (JP) 2011-275114
Nov. 14, 2012 (JP) 2012-250079

(51) Int. Cl. G09G 5/34

(52) U.S. Cl. CPC G09G 5/34
USPC 345/649

(57) ABSTRACT

A projection display device includes an image generating part which generates an image to be displayed on a predetermined image display surface; a circuit part which operates the image generating part based on an image signal; an image acquiring part which acquires an image signal to be outputted from a mobile device; a tilt acquiring part which acquires, from the mobile device, a tilt signal indicating a tilt angle of a display surface of the mobile device with respect to a reference state; and screen state changing part which changes a state of a screen to be displayed on the image display surface in accordance with the tilt signal. The screen state changing part inclines, on the image display surface, an image based on the image signal acquired by the image acquiring part, based on the tilt signal in accordance with the inclination of the display surface.

This application claims priority under 35 U.S.C. Section 119 of Japanese Patent Application No. 2011-275114 filed Dec. 15, 2011, entitled “PROJECTION DISPLAY DEVICE AND MOBILE DEVICE” and Japanese Patent Application No. 2012-250079 filed Nov. 14, 2012, entitled “IMAGE DISPLAY DEVICE AND MOBILE DEVICE”. The disclosures of the above applications are incorporated herein by reference.

### BACKGROUND OF THE INVENTION

1. Field of the Invention

The present invention relates to an image display device such as a projection display device configured to modulate light from a light source for projecting the modulated light onto a projection plane, a monitor display, and a television. The present invention further relates to a mobile device such as a portable game device and a mobile phone.

2. Disclosure of Related Art

Conventionally, in a projection display device (hereinafter, called as a projector) as one of image display devices, light emitted from a light source is modulated by an image modulator, and the modulated light is projected onto a projection plane such as a screen. Such a projector is provided with a keystone correction function for eliminating an inclination or distortion of an image projected onto a screen. By performing the keystone correction process, a state of an image is changed in such a manner as to eliminate the inclination or distortion of the image.

A mobile device such as a portable game device or a mobile phone may be connected to a projector, so that an image signal is inputted from the mobile device to the projector. In this case, a screen (display screen) to be displayed on a display surface of the mobile device is projected onto a screen by the projector. By the projecting operation, for instance, in the case where an application program of a certain game software is executed in the mobile device, a game screen is enlarged and projected onto the screen. Thus, the user can enjoy the game screen with realistic feeling. In the case where a mobile device is connected to a monitor display, a television, more preferably, a large monitor display or a large television, the user can also enjoy a game screen with realistic feeling.

In recent years, there has been widely used a mobile device provided with a sensor for detecting an inclination of the mobile device so that the inclination detected by the sensor is acquired as one of user's input operations with respect to a game screen. As described above, in the case where a game screen of a mobile device is projected onto a screen by a projector, if the user recognizes as if an image of the game screen projected onto the screen is inclined in accordance with an inclination of the game screen, the user feels more realistic feeling.

As described above, a conventional projector is provided with a keystone correction function, as a function for changing a state of an image on a screen. However, the keystone correction function is merely a function for eliminating an inclination or distortion of an image on a screen. Therefore, in the conventional projector, it may be difficult or impossible to incline an image on a screen in accordance with an inclination of a mobile device.

### SUMMARY OF THE INVENTION

A projection display device according to a first aspect of the invention includes an image generating part which generates an image to be displayed on a predetermined image display surface; a circuit part which operates the image generating part based on an image signal; an image acquiring part which acquires an image signal to be outputted from a mobile device for supplying the image signal to the circuit part; a tilt acquiring part which acquires, from the mobile device, a tilt signal indicating a tilt angle of a display surface of the mobile device with respect to a reference state; and screen state changing part which changes a state of a screen to be displayed on the image display surface in accordance with the tilt signal. In the above arrangement, the screen state changing part inclines, on the image display surface, an image based on the image signal acquired by the image acquiring part, based on the tilt signal in accordance with the inclination of the display surface.

A mobile device according to a second aspect of the invention includes a display part which is configured to display, on a display surface, a screen based on an image signal; an image supplying part which supplies, to an external device, the image signal for forming the screen to be displayed on the display surface; and a tilt supplying part which supplies, to the external device, a tilt signal indicating an inclination of the display surface with respect to a reference state, concurrently with supply of the image signal.

### BRIEF DESCRIPTION OF THE DRAWINGS

These and other objects, and novel features of the present invention will become more apparent upon reading the following detailed description of the embodiments along with the accompanying drawings.

FIGS. 1A and 1B are diagrams showing arrangements of a projector and a mobile device embodying the invention.

FIGS. 2A through 2C are diagrams showing an internal structure of the projector according to the embodiment.

FIG. 3 is a diagram showing arrangements of an optical engine and a projection lens unit according to the embodiment.

FIG. 4 is a block diagram showing an arrangement of the projector according to the embodiment.

FIG. 5 is a block diagram showing an arrangement of the mobile device according to the embodiment.

FIGS. 6A and 6B are flowcharts showing a control process for inclining an image of a display screen of the mobile device projected onto a screen in accordance with an inclination of a display surface of the mobile device according to the embodiment.

FIGS. 7A through 7C are diagrams each showing a movement of an image of a display screen of the mobile device to be displayed on a screen, in the case where a user inclines a display surface of the mobile device when the image of the display screen of the mobile device is projected onto the screen according to the embodiment.

FIGS. 8A and 8B are diagrams showing an arrangement of a projector as a modification.

FIG. 9 is a flowchart showing a control process for inclining an image of a display screen of a mobile device projected onto a screen in accordance with an inclination of a display surface of the mobile device in the modification.

FIGS. 10A through 10C are diagrams each showing a movement of an image of a display screen of the mobile device to be displayed on a screen, in the case where a user inclines a display surface of the mobile device when the image of the display screen of the mobile device is projected onto the screen in the modification.

FIGS. 11A through 11C are diagrams each showing a movement of an image of a display screen of the mobile device to be displayed on a screen, in the case where a user inclines a display surface of the mobile device when the image of the display screen of the mobile device is projected onto the screen in the modification.

FIGS. 12A and 12B are diagrams for describing an arrangement of a projector in another modification.

FIGS. 13A and 13B are diagrams showing an arrangement of a liquid crystal display according to another embodiment.

FIG. 14 is a flowchart showing a control process for inclining an image of a display screen of a mobile device, which is displayed on a display surface of the liquid crystal display, in accordance with an inclination of a display surface of the mobile device according to another embodiment.

FIGS. 15A through 15C are diagrams each showing a movement of an image of a display screen of the mobile device on the display surface of the liquid crystal display, in the case where a user inclines the display surface of the mobile device when the image of the display screen of the mobile device is displayed on the display surface of the liquid crystal display according to another embodiment.

The drawings are provided mainly for describing the present invention, and do not limit the scope of the present invention.

### DESCRIPTION OF PREFERRED EMBODIMENTS

In the following, a projector and a mobile device embodying the invention are described referring to the drawings.

In the embodiments, an optical engine 202, an image modulator 215, and a liquid crystal panel 604a correspond to an “image generating part” in the claims. A second controller 231, a controller 411, a controller 611, an image signal processor 235, an image signal processor 416, and an image signal processor 616 correspond to a “circuit part” in the claims. A signal input part 226, a signal input part 415, and a signal input part 615 correspond to an “image acquiring part” and a “tilt acquiring part” in the claims. A projection lens unit 203 and a projection lens unit 403 correspond to a “projection part” in the claims. A light source part 211 correspond to a “light source” in the claims. A first controller 221 corresponds to a “driving controller” in the claims. A keystone corrector 419 and a keystone corrector 619 correspond to a “signal processor” in the claims. A controller 302 corresponds to an “image supplying part” and a “tilt supplying part” in the claims. Atilt detector 305 corresponds to a “tilt supplying part” in the claims. An image signal processor 306 corresponds to an “image supplying part” in the claims. A signal output part 307 corresponds to an “image supplying part” and a “tilt supplying part” in the claims. A display surface 604c corresponds to an “image display surface” in the claims. The description regarding the correspondence between the claims and the embodiments is merely an example, and the claims are not limited by the description of the embodiments.

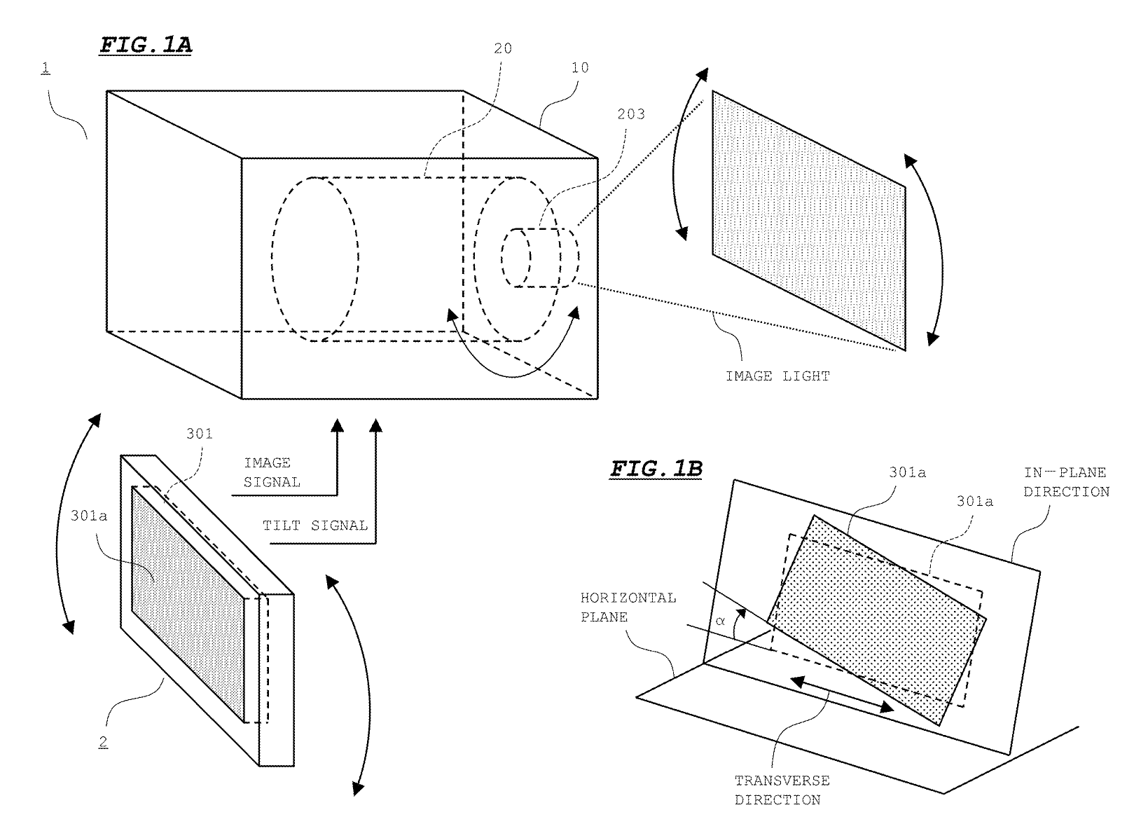

FIGS. 1A and 1B are diagrams showing arrangements of a projector 1 and a mobile device 2. FIG. 1A shows perspective views of the projector 1 and the mobile device 2. FIG. 1B is a diagram for describing a tilt signal to be outputted from the mobile device 2.

The projector 1 is an easily-portable and compact projector. The projector 1 is provided with a base unit 10, and a projection display unit 20 rotatably held in the base unit 10. A projection lens unit 203 constituting the projection display unit 20 projects forwardly from a front surface of the base unit 10. The projection display unit 20 is configured to rotate in an in-plane direction perpendicular to an emission direction of image light from the projection lens unit 203.

The mobile device 2 is e.g. a portable game device or a mobile phone. The mobile device 2 is provided with a display part 301. A display surface 301a of the display part 301 is exposed to the exterior. Various display screens are displayed on the display surface 301a. For instance, in the case where an application program of a certain game software is executed in the mobile device 2, a game screen is displayed on the display surface 301a.

An image signal is outputted from the mobile device 2 to the projector 1 for projecting, onto a screen, a projection screen including an image of a display screen to be displayed on the display surface 301a. Further, a tilt signal is outputted from the mobile device 2 to the projector 1.

In the embodiment, as shown in FIG. 1B, a state that a transverse direction of the display surface 301a is in parallel to a horizontal plane is defined as a reference state. A tilt signal indicates a tilt angle α of the display surface 301a with respect to the reference state in an in-plane direction of the display surface 301a. In the case where the display surface 301a is inclined from the reference state in the in-plane direction, the projection display unit 20 rotates in accordance with the inclination of the display surface 301a, and a projection screen projected onto a screen i.e. an image of a display screen of the mobile device 2 is inclined in the same manner as the display screen displayed on the display surface 301a.

The following is a detailed description of an arrangement as to how an image of a display screen to be displayed on a screen is inclined in accordance with an inclination of the display surface 301a.

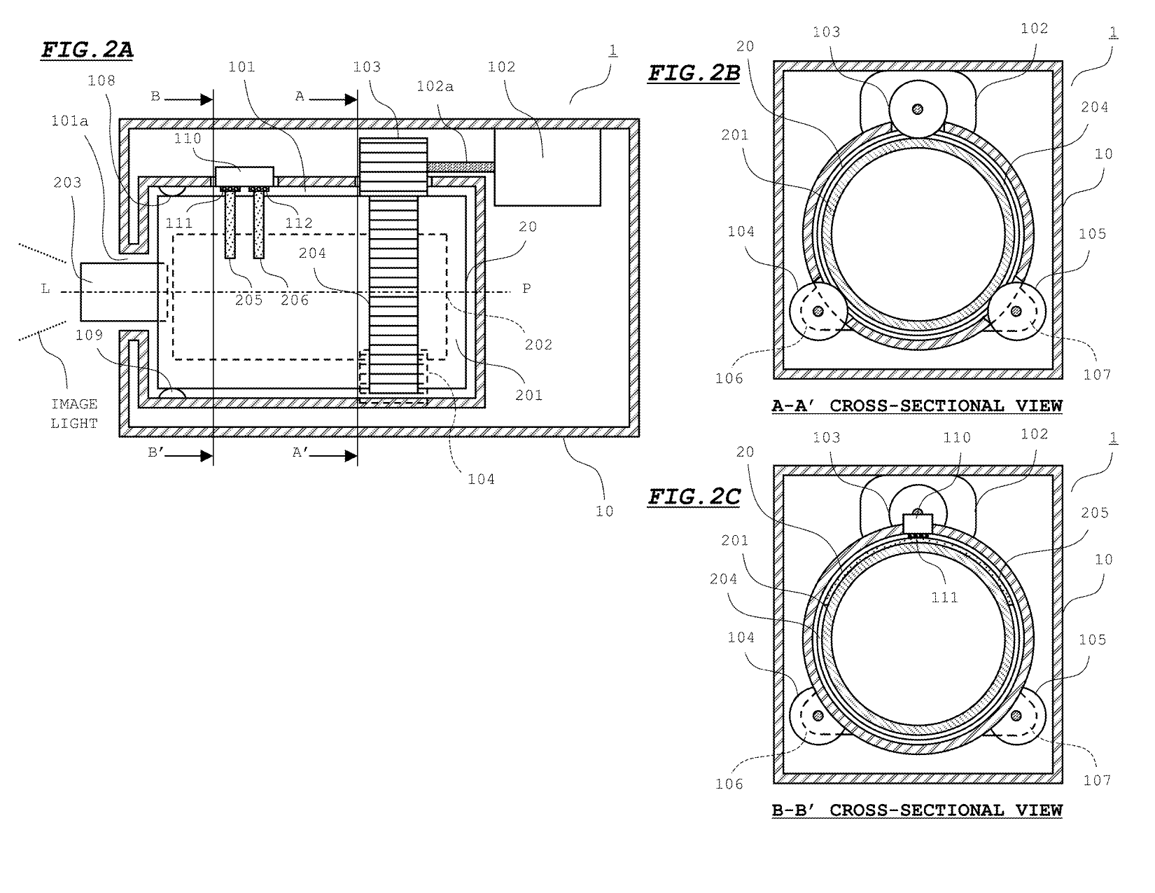

FIGS. 2A through 2C are diagrams showing an internal structure of the projector 1. FIG. 2A is a cross-sectional view of the projector 1 when viewed in a transverse direction, and FIGS. 2B and 2C are cross-sectional views of the projector 1 when viewed from a front side. FIG. 2B is a cross-sectional view taken along the line A-A′ in FIG. 2A, and FIG. 2C is a cross-sectional view taken along the line B-B′ in FIG. 2A.

A housing 101 configured to house the projection display unit 20 therein is formed in the base unit 10. The housing 101 has a substantially tubular shape. A motor 102 is disposed behind the housing 101 at an upper portion within the base unit 10. A driving gear 103 is mounted on a rotary shaft 102a of the motor 102. A part of the driving gear 103 is exposed to the interior of the housing 101 at a rear portion of the housing 101.

Left and right supporting gears 104 and 105 are disposed at a lower portion within the base unit 10. The supporting gear 104 is rotatably supported on a supporting portion 106, and the supporting gear 105 is rotatably supported on a supporting portion 107. Respective parts of the supporting gears 104 and 105 are exposed to the interior of the housing 101 at the rear portion of the housing 101.

Hemispherical upper and lower supporting projections 108 and 109 are formed at a front portion within the housing 101. An output terminal part 110 is disposed behind the supporting projection 108 at an upper portion of the housing 101. Two power source output terminals 111 and 112 are disposed on the output terminal part 110. The power source output terminals 111 and 112 are exposed to the interior of the housing 101.

The projection display unit 20 is provided with a cabinet 201, an optical engine 202, and a projection lens unit 203. The cabinet 201 has a substantially tubular shape. An annular rack gear 204 is disposed on the outer circumferential surface of the cabinet 201 at a rear portion of the cabinet 201. The rack gear 204 is meshed with the driving gear 103 and with the left and right supporting gears 104 and 105, whereby the rear portion of the cabinet 201 is rotatably supported on the gears 103, 104, and 105. Further, a front portion of the cabinet 201 is contacted with the upper and lower supporting projections 108 and 109, whereby a front portion of the cabinet 201 is rotatably supported on the supporting projections 108 and 109.

The optical engine 202 and the projection lens unit 203 are disposed in the cabinet 201.

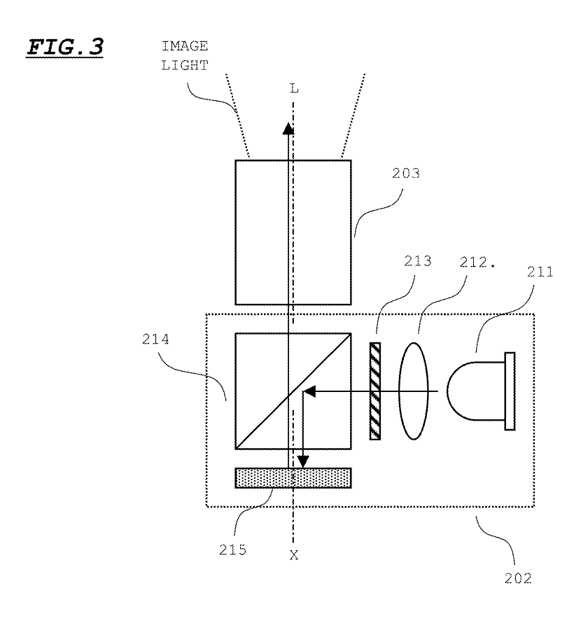

FIG. 3 is a diagram showing arrangements of the optical engine 202 and the projection lens unit 203.

The optical engine 202 is provided with a light source part 211, a free curved surface lens 212, a PBS array 213, a PBS 214, and an image modulator 215.

The light source part 211 is constituted of an LED configured to emit white light. Light emitted from the light source part 211 is entered to the free curved surface lens 212. The free curved surface lens 212 exhibits a lens function so that the entered light is properly irradiated onto the image modulator 215. Light outputted from the free curved surface lens 212 is transmitted through the PBS array 213, whereby the polarization direction of light is aligned with the polarization direction of S-polarized light with respect to the PBS 214. S-polarized light transmitted through the PBS array 213 is reflected on the PBS 214, and the reflected light is irradiated onto the image modulator 215.

The image modulator 215 is constituted of a reflective liquid crystal panel having color filters of R, G, and B. The image modulator 215 modulates light (hereinafter, called as R light) in a red wavelength band, light (hereinafter, called as G light) in a green wavelength band, and light (hereinafter, called as B light) in a blue wavelength band that have been transmitted through the respective color filters of R, G, and B; and reflects the modulated light based on an image signal.

R light, G light, and B light outputted from the image modulator 215 are transmitted through the PBS 214 in accordance with the polarization direction thereof, and entered to the projection lens unit 203 as image light for forming a projection screen on a screen. In this example, the center axis X of the image modulator 215 coincides with the optical axis L of the projection lens unit 203. Image light is entered to the projection lens unit 203 in a state that the center axis of image light coincides with the optical axis L1 of the projection lens unit 203.

The projection lens unit 203 enlarges and projects, onto a screen, image light outputted from the optical engine 202. A projection screen projected onto the screen has a transversely long rectangular shape. The projection lens unit 203 includes a focus lens (not shown) movable in the optical axis direction of the projection lens unit 203. Focus adjustment is performed by moving the focus lens in forward and backward directions.

Referring back to FIGS. 2A through 2C, the projection lens unit 203 projects forwardly from a front surface of the cabinet 201. Further, the projection lens unit 203 projects forwardly of the base unit 10 through an opening 101a formed in the housing 101.

Two power source input terminals 205 and 206 are disposed on the outer circumferential surface of the cabinet 201. Each of the power source input terminals 205 and 206 is constituted of an arc-shaped and elongated metal plate. The power source output terminals 111 and 112 of the output terminal part 110 are respectively contacted with the power source input terminals 205 and 206.

In response to rotation of the motor 102, the driving gear 103 rotates, and a rotation force of the driving gear 103 is transmitted to the rack gear 204, whereby the cabinet 201 i.e. the projection display unit 20 rotates. The center axis P of the cabinet 201 coincides with the optical axis L of the projection lens unit 203 i.e. the center axis of image light. Accordingly, the cabinet 201 rotates about the center axis of image light as an axis of rotation.

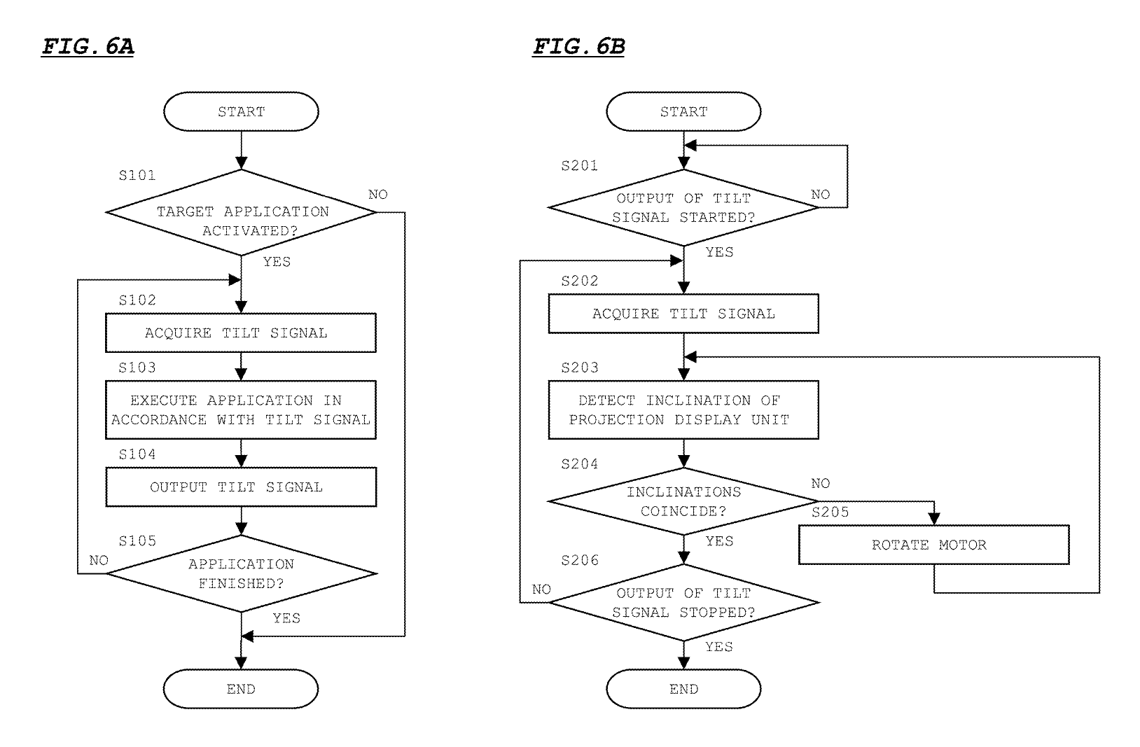

In the case where the projection display unit 20 is in a reference position, a projection screen to be formed on a screen is brought to a horizontal state i.e. a state that the transverse direction of the projection screen is in parallel to a horizontal plane (see FIG. 6A). The projection display unit 20 rotates clockwise or counterclockwise from the reference position by a predetermined upper limit angle. The projection screen on the screen is inclined from the horizontal state by the angle, by which the projection display unit 20 rotates from the reference position (see FIG. 6B and FIG. 6C).

In response to rotation of the projection display unit 20, the power source output terminals 111 and 112 slide on the corresponding power source input terminals 205 and 206. As a result, it is possible to supply electric power to the projection display unit 20, even if the projection display unit 20 rotates.

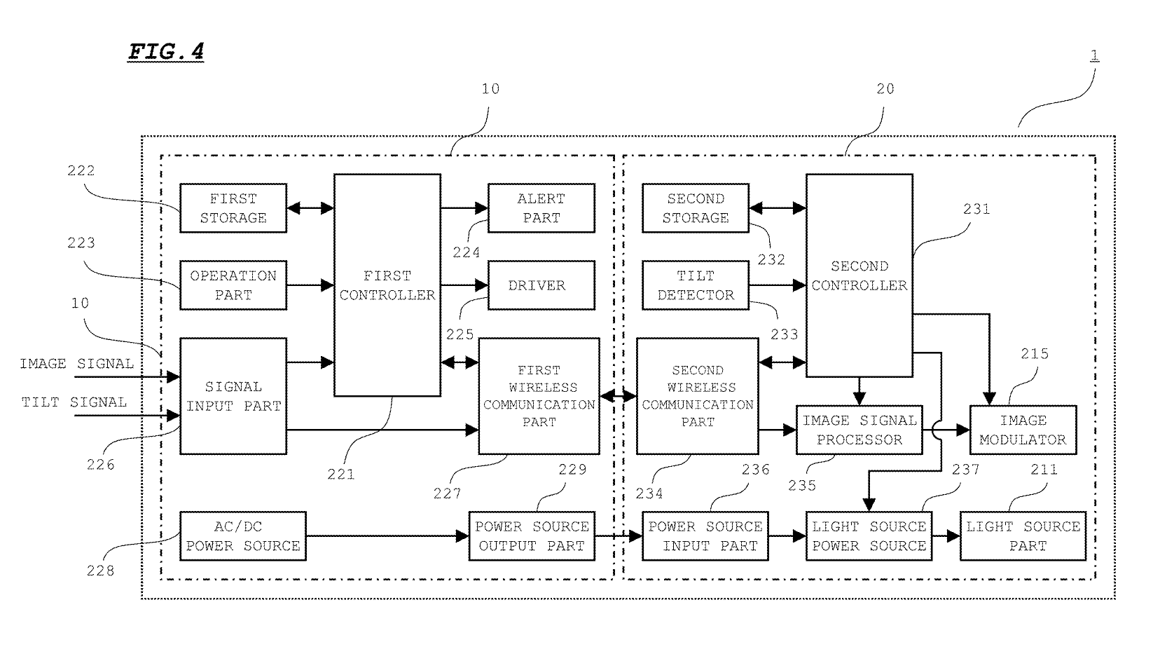

FIG. 4 is a block diagram showing an arrangement of the projector 1. The base unit 10 is provided with a first controller 221, a first storage 222, an operation part 223, an alert part 224, a driver 225, a signal input part 226, a first wireless communication part 227, an AC/DC power source 228, and a power source output part 229, in addition to the elements shown in FIGS. 2A through 2C.

The operation part 223 is provided with various operation keys relating to operations of the base unit 10 and the projection display unit 20. The operation part 223 outputs an operation signal to the first controller 221 in response to a user's key operation. The alert part 224 alerts the user of e.g. an operation state of the projector 1 and various errors.

The driver 225 includes the motor 102 and a driving circuit for driving the motor 102.

The signal input part 226 acquires an image signal and a tilt signal outputted from the mobile device 2, outputs the image signal to the first wireless communication part 227, and outputs the tilt signal to the first controller 221. In the case where an image signal and a tilt signal are transmitted/received by wire, the signal input part 226 is configured to include an input terminal for inputting the image signal, and an input terminal for inputting the tilt signal. On the other hand, in the case where an image signal and a tilt signal are transmitted/received wirelessly, the signal input part 226 is configured to include a receiving circuit for receiving the image signal and the tilt signal as wireless signals.

The first wireless communication part 227 modulate an image signal inputted from the signal input part 226 into a wireless signal, and transmits the modulated image signal to a second wireless communication part (to be described later) of the projection display unit 20. Further, the first wireless communication part 227 modulates an operation signal relating to the projection display unit 20 from the first wireless communication part 227 via the first controller 221 into a wireless signal, and transmits the modulated image signal to the second wireless communication part. Furthermore, the first wireless communication part 227 receives a tilt signal as a wireless signal from the second wireless communication part, demodulates the tilt signal as the wireless signal, and outputs the demodulated tilt signal to the first controller 221.

The AC/DC power source 228 converts AC electric power supplied from a commercial power source into DC electric power, and sends the DC electric power to the power source output part 229. The power source output part 229 includes the output terminal part 110, and sends the electric power to a power source input part (to be described later) of the projection display unit 20 via the power source output terminals 111 and 112.

The first storage 222 is constituted of an RAM, an ROM, and the like. The first storage 222 stores a control program for causing the first controller 221 to exhibit a certain control function.

The first controller 221 is provided with a CPU. The first controller 221 controls the alert part 224, the driver 225, and the first wireless communication part 227 in accordance with a control program stored in the first storage 222, based on e.g. an operation signal from the operation part 223 relating to the base unit 10, a tilt signal from the signal input part 226, and a tilt signal from the projection display unit 20.

Electric power is supplied from an unillustrated power source part to e.g. the first controller 221, the first storage 222, and the driver 225. Electric power is supplied from the AC/DC power source 228 to the power source part.

The projection display unit 20 is provided with a second controller 231, a second storage 232, a tilt detector 233, a second wireless communication part 234, an image signal processor 235, a power source input part 236, and a light source power source 237, in addition to the elements shown in FIGS. 2A through 2C, and FIG. 3.

The tilt detector 233 includes an acceleration sensor. In response to rotation of the projection display unit 20 from a state that the projection display unit 20 is in the reference position, the tilt detector 233 outputs, to the second controller 231, a tilt signal indicating a tilt angle of the projection display unit 20 with respect to the reference position. The tilt signal is then outputted from the second controller 231 to the second wireless communication part 234.

The second wireless communication part 234 demodulates an image signal and an operation signal as wireless signals from the first wireless communication part 227, outputs the demodulated image signal to the image signal processor 235, and outputs the demodulated operation signal to the second controller 231. Further, the second wireless communication part 234 modulates a tilt signal inputted from the second controller 231 into a wireless signal, and outputs the modulated tilt signal to the first wireless communication part 227.

The image signal processor 235 applies various processes to an image signal inputted from the second wireless communication part 234 in accordance with a control signal from the second controller 231 for generating an image signal suitable for the image modulator 215, and outputs the generated image signal to the image modulator 215. For instance, in response to input of an image signal relating to a display screen to be displayed on the display surface 301a of the mobile device 2, the image signal processor 235 generates an image signal for forming a projection screen including the display screen on a screen.

The power source input part 236 includes the power source input terminals 205 and 206, receives electric power from the power source output part 229 via the power source input terminals 205 and 206, and sends the electric power to the light source power source 237.

The light source power source 237 generates electric power suitable for driving the light source part 211, out of the electric power sent from the power source input part 236. The light source power source 237 supplies the generated electric power to the light source part 211 in accordance with a control signal from the second controller 231 for driving the light source part 211.

The second storage 232 is constituted of an RAM, an ROM, and the like. The second storage 232 stores a control program for causing the second controller 231 to exhibit a certain control function.

The second controller 231 is provided with a CPU. The second controller 231 controls the image signal processor 235, the image modulator 215, and the light source power source 237 in accordance with a control program stored in the second storage 232, based on e.g. an operation signal from the second wireless communication part 234 relating to the projection display unit 20.

Electric power is supplied from an unillustrated power source part to e.g. the second controller 231, the second storage 232, the image signal processor 235, and the image modulator 215. Electric power is supplied from the power source input part 236 to the power source part.

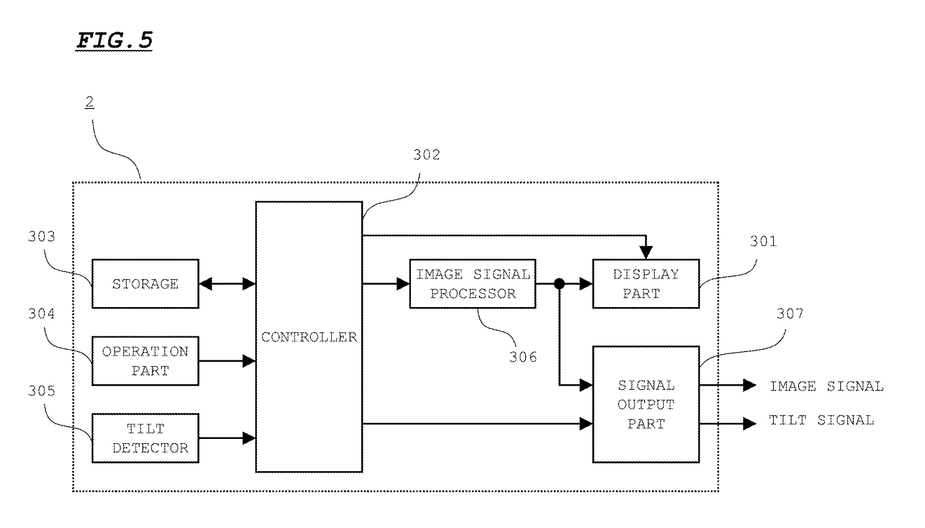

FIG. 5 is a block diagram showing an arrangement of the mobile device 2.

The mobile device 2 is provided with a controller 302, a storage 303, an operation part 304, a tilt detector 305, an image signal processor 306, and a signal output part 307, in addition to the display part 301.

The operation part 304 is provided with various operation keys, and outputs an operation signal to the controller 302 in response to a user's key operation. Further, the operation part 304 includes a touch sensor disposed on the display surface 301a of the display part 301, and outputs, to the controller 302, an operation signal in response to user's manipulation on the display surface 301a.

The tilt detector 305 includes an acceleration sensor. The tilt detector 305 outputs, to the controller 302, a tilt signal indicating a tilt angle α of the display surface 301a, as shown in FIG. 1B.

The storage 303 is constituted of an RAM, an ROM, and the like. The storage 303 stores a control program for causing the controller 302 to exhibit a certain control function. Further, the storage 303 stores various application programs (hereinafter, simply called as “applications”) including game softwares.

The controller 302 is provided with a CPU. The controller 302 controls the image signal processor 306 and the display part 301 in accordance with a control program stored in the storage 303, based on e.g. an operation signal from the operation part 304, and a tilt signal from the tilt detector 305. For instance, in the case where an application is executed, the controller 302 reads out image data relating to an execution screen of the application from the storage 303, and outputs the readout image data to the image signal processor 306. Further, in the case where an application designating an operation of inclining the display surface 301a as one of the input operations is executed, the controller 302 executes the application based on a tilt signal from the tilt detector 305, and also outputs the tilt signal to the signal output part 307.

The image signal processor 306 processes image data outputted from the controller 302, and generates an image signal suitable for the display part 301. The generated image signal is outputted to the display part 301, and is also outputted to the signal output part 307.

The display part 301 is e.g. a liquid crystal display, and displays a display screen in accordance with an inputted image signal on the display surface 301a.

The signal output part 307 outputs, to the projector 1, an image signal outputted from the image signal processor 306, and a tilt signal outputted from the controller 302. In the case where an image signal and a tilt signal are transmitted/received by wire, the signal output part 307 is configured to include an output terminal for outputting the image signal, and an output terminal for outputting the tilt signal. On the other hand, in the case where an image signal and a tilt signal are wirelessly transmitted/received, the signal output part 307 is configured to include a transmitting circuit for transmitting the image signal and the tilt signal as wireless signals.

FIGS. 6A and 6B are flowcharts showing a control process for inclining an image of a display screen of the mobile device 2 projected onto a screen in accordance with an inclination of the display surface 301a of the mobile device 2. The flowchart of FIG. 6A shows a control process to be executed by the mobile device 2, and the flowchart of FIG. 6B shows a control process to be executed by the projector 1.

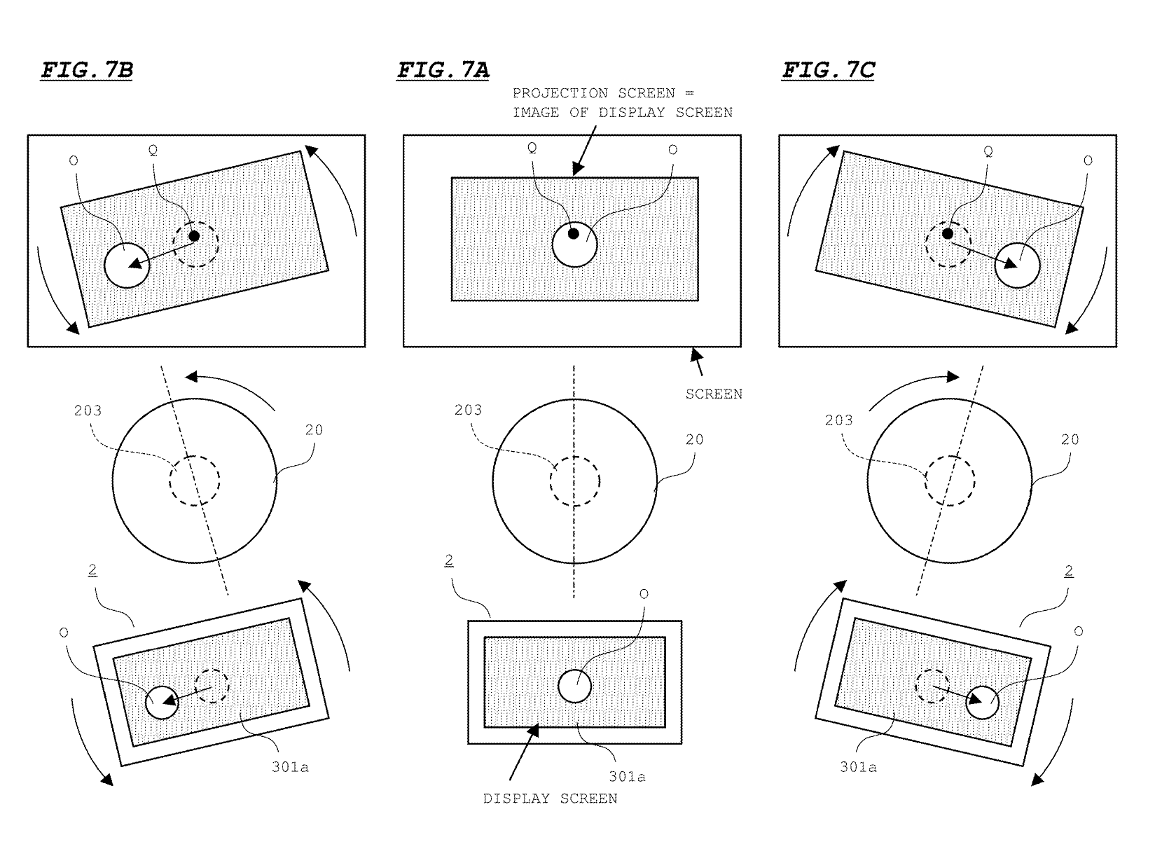

In the case where a projecting operation by the projector 1 is started in a state that the mobile device 2 and the projector 1 are connected to each other so that an image signal and a tilt signal are inputted from the mobile device 2 to the projector 1, a projection screen including an image of a display screen (e.g. an execution screen of an application) displayed on the display surface 301a of the mobile device 2 is projected onto a screen by the projection display unit 20. In this embodiment, the entirety of a projection screen is constituted of an image of a display screen. In other words, an image of a display screen has substantially the same size as the size of a projection screen (see FIG. 7A).

Referring to FIG. 6A, in the mobile device 2, in the case where the controller 302 determines that an activated application is an application designating an operation of inclining the display surface 301a as one of the input operations (S101: YES), the controller 302 acquires a tilt signal from the tilt detector 305 (S102), and executes the application in accordance with the acquired tilt signal (S103). Then, the controller 302 outputs the acquired tilt signal (S104). The outputted tilt signal is transmitted to the projector 1 via the signal output part 307.

During execution of the application (S105: NO), the controller 302 repeats the processes from Step S102 through Step S104 at a predetermined time interval. In the case where the application is finished (S105: YES), the control process is ended.

Referring to FIG. 6B, in the projector 1, in the case where output of a tilt signal from the mobile device 2 is started (S201: YES), the first controller 221 acquires the tilt signal from the mobile device 2 (S202). Then, the first controller 221 detects an inclination of the projection display unit 20, based on the tilt signal from the projection display unit 20 (S203).

In the case where the inclination of the projection display unit 20 does not coincide with the inclination of the mobile device 2 (S204: NO), the first controller 221 causes the motor 102 to rotate in such a direction that the inclinations coincide with each other until the inclinations coincide with each other (S205). While the output of a tilt signal from the mobile device 2 is continued (S206: NO), the first controller 221 repeats the processes from Step S202 through Step S205 at a predetermined time interval. In the case where the output of a tilt signal from the mobile device 2 is stopped (S206: YES), the control process is ended.

FIGS. 7A through 7C are diagrams each showing a movement of an image of a display screen of the mobile device 2 to be displayed on a screen, in the case where the user inclines the display surface 301a when the image of the display screen of the mobile device 2 is projected onto the screen.

As shown in FIG. 7A, in the case where the display surface 301a is in the reference state, the projection display unit 20 is kept to the reference position, and a projection screen on a screen i.e. an image of a display screen is brought to a horizontal state. For instance, in the case where the display screen is a game execution screen configured to move an object O in accordance with the tilt angle α of the display surface 301a, the object O on the display screen is brought to a stopped state.

As shown in FIG. 7B, in the case where the display surface 301a is inclined counterclockwise from the state shown in FIG. 7A, the object O on the display screen is moved leftwardly in accordance with the tilt angle α of the display surface 301a. Further, by rotating the projection display unit 20 counterclockwise, the image of the display screen on the screen is inclined counterclockwise in accordance with the tilt angle α of the display surface 301a. With this arrangement, the user viewing the screen recognizes as if the object O is moving leftwardly resulting from inclination of the image of the display screen.

On the other hand, as shown in FIG. 7C, in the case where the display surface 301a is inclined clockwise from the state shown in FIG. 7A, the object O on the display screen is moved rightwardly in accordance with the tilt angle α of the display surface 301a. Further, by rotating the projection display unit 20 clockwise, the image of the display screen on the screen is inclined clockwise in accordance with the tilt angle α of the display surface 301a. With this arrangement, the user viewing the screen recognizes as if the object O is moving rightwardly resulting from inclination of the image of the display screen.

In this way, as the display surface 301a is inclined from the reference state, an image of a display screen projected onto a screen is inclined in accordance with the inclination of the display surface 301a.

In this example, the projection display unit 20 rotates about the center axis of image light as an axis of rotation. Accordingly, a projection screen on a screen i.e. an image of a display screen is inclined to rotate about the center Q of the projection screen as a center of rotation.

As described above, in the embodiment, for instance, in the case where the user inclines the display surface 301a from the reference state for an input operation in a state that an image of a display screen displayed on the display surface 301a of the mobile device 2 is projected onto a screen, the image of the display screen on the screen is inclined in accordance with the inclination of the display surface 301a. The above arrangement is advantageous in providing the user with more realistic feeling, as compared with an arrangement that an image of a display screen is simply enlarged and projected onto a screen.

Further, in the embodiment, in the case where the display surface 301a of the mobile device 2 is inclined, the projection display unit 20 rotates in accordance with the inclination of the display surface 301a. As a result, a projection screen rotates, and an image of a display screen to be included in the projection screen is inclined. Accordingly, it is not necessary to apply a signal processing to an image signal from the mobile device 2 for inclining an image of a display screen.

Further, in the embodiment, in the case where the user inclines the display surface 301a from a state that the transverse direction of the display surface 301a is in parallel to a horizontal plane in an in-plane direction of the display surface 301a, the projection display unit 20 rotates in an in-plane direction perpendicular to the emission direction of image light, and a projection screen i.e. an image of a display screen is inclined from a state that the transverse direction of the projection screen is in parallel to a horizontal plane in an in-plane direction of a screen (see FIG. 7B and FIG. 7C). In this case, the user can recognize the image of the display screen in a satisfactory manner, because the image of the display screen formed on the screen is not distorted into a trapezoidal shape.

Further, in the embodiment, by rotating the projection display unit 20 about the center axis of image light as an axis of rotation, a projection screen on a screen is inclined to rotate about the center Q of the screen as a center of rotation. Accordingly, there is no likelihood that the projection screen may intolerably swing in left and right directions on the screen, and, the projection screen is less likely to be deviated from the screen.

### Modifications

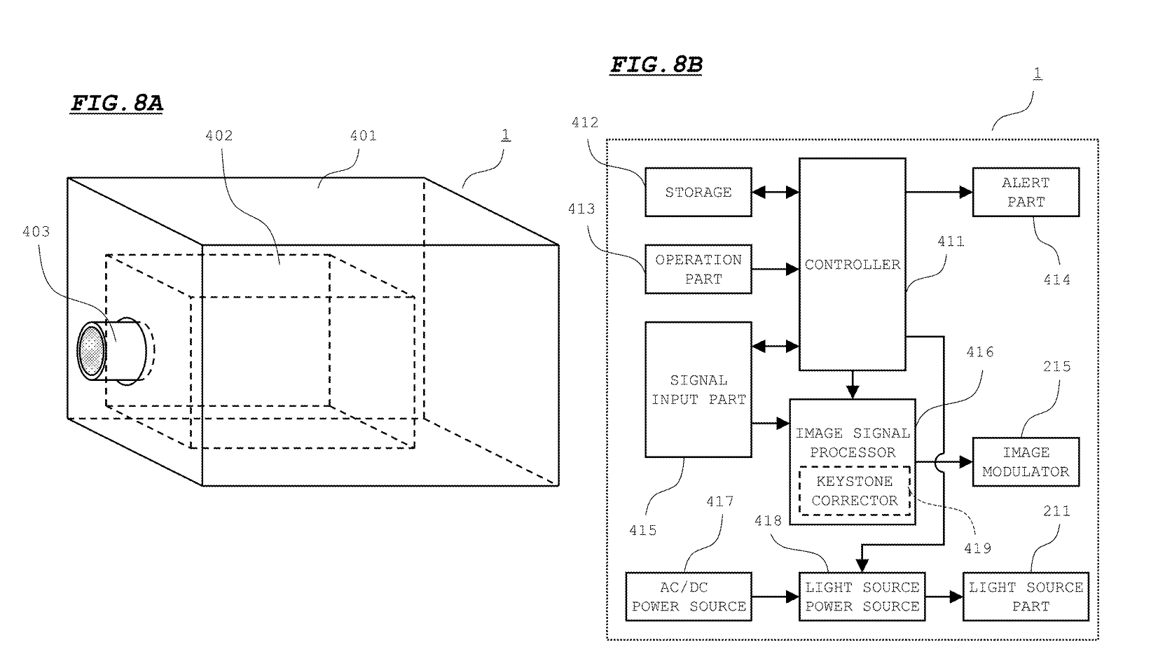

FIGS. 8A and 8B are diagrams showing an arrangement of a projector 1 as a modification. FIG. 8A is a perspective view of the projector 1, and FIG. 8B is a block diagram of the projector 1.

In the embodiment, the projector 1 is configured to incline an image of a display screen projected onto a screen in accordance with an inclination of the display surface 301a of the mobile device 2 by providing a rotation mechanism configured to rotate the projection display unit 20 in the projector 1. In the modification, by applying a signal processing to an image signal from a mobile device 2, an image of a display screen projected onto a screen is inclined in accordance with an inclination of a display surface 301a of the mobile device 2.

As shown in FIG. 8A, the projector 1 is provided with an optical engine 402 and a projection lens unit 403 in a main body cabinet 401. A front portion of the projection lens unit 403 projects forwardly from a front surface of the main body cabinet 401. The arrangements of the optical engine 402 and the projection lens unit 403 are substantially the same as the arrangements of the optical engine 202 and the projection lens unit 203 in the embodiment.

As shown in FIG. 8B, the projector 1 is further provided with a controller 411, a storage 412, an operation part 413, an alert part 414, a signal input part 415, an image signal processor 416, an AC/DC power source 417, and a light source power source 418. The arrangements of the controller 411, the storage 412, the operation part 413, the alert part 414, the signal input part 415, the image signal processor 416, the AC/DC power source 417, and the light source power source 418 are respectively substantially the same as the arrangements of the second controller 231, the second storage 232, the operation part 223, the alert part 224, the signal input part 226, the image signal processor 235, the AC/DC power source 228, and the light source power source 237 in the embodiment.

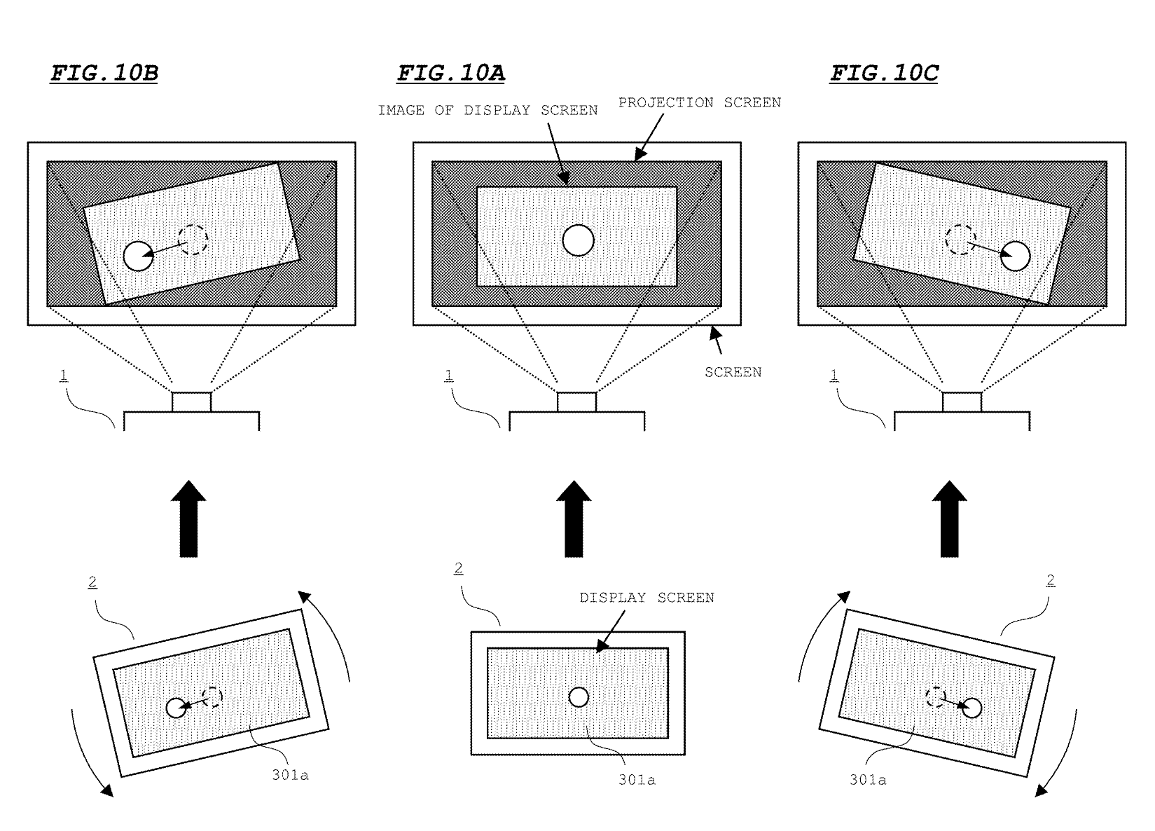

The image signal processor 416 is provided with a keystone corrector 419. The keystone corrector 419 receives, from the signal input part 415, an image signal and a tilt signal derived from the mobile device 2. The keystone corrector 419 applies a keystone correction process to the image signal from the mobile device 2 in accordance with the tilt signal, and generates an image signal for displaying an inclined image. Light from a light source part 211 is modulated by an image modulator 215 in accordance with the image signal for displaying an inclined image, whereby a projection screen, in which an image of a display screen displayed on the display surface 301a is inclined, is projected onto a screen in accordance with a tilt angle α of the display surface 301a of the mobile device 2 (see FIGS. 10B and 10C).

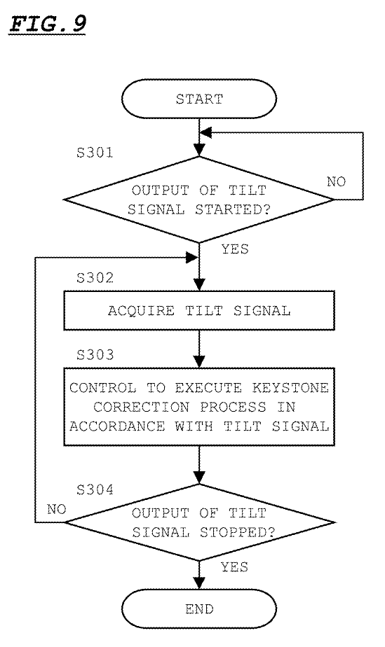

FIG. 9 is a flowchart showing a control process for inclining an image of a display screen of the mobile device 2 projected onto a screen in accordance with an inclination of the display surface 301a of the mobile device 2 in the modification. FIGS. 10A through 10C are diagrams each showing a movement of an image of a display screen on a screen, in the case where the user inclines the display surface 301a when the image of the display screen of the mobile device 2 is projected onto the screen in the modification.

The control process for transmitting a tilt signal from the mobile device 2 in the modification is substantially the same as the control process described in the embodiment referring to FIG. 6A.

Referring to FIG. 9, in the projector 1, in response to start of output of a tilt signal from the mobile device 2 (S301: YES), the controller 411 acquires the tilt signal from the mobile device 2 (S302). Then, the controller 411 provides the image signal processor 416 with an instruction to execute a keystone correction process in accordance with the tilt signal (S303).

As shown in FIG. 10A, in the case where the display surface 301a is in a reference state, an image signal for displaying an inclined image so as to form a projection screen including an image of a display screen in a horizontal state is generated by a keystone correction process by the keystone corrector 419. Then, a projection screen based on the generated image signal is displayed on a screen. A projection screen to be formed by the keystone correction process is displayed in such a manner that the image of the display screen is displayed with a size smaller than the size of the projection screen, and that the outer region of the image of the display screen is formed of a predetermined background color (e.g. black).

As shown in FIG. 10B, in the case where the display surface 301a is inclined counterclockwise from the state shown in FIG. 10A, an image signal for displaying an inclined image so as to form a projection screen including an image of a display screen, which is inclined counterclockwise by an angle substantially equal to the tilt angle α of the display surface 301a, is generated by a keystone correction process by the keystone corrector 419. Then, a projection screen based on the generated image signal is displayed on a screen. A projection screen to be formed by the keystone correction process is displayed in such a manner that the image of the display screen is displayed with a size smaller than the size of the projection screen and with a counterclockwise inclination, and that the outer region of the image of the display screen is formed of a predetermined background color.

On the other hand, as shown in FIG. 10C, in the case where the display surface 301a is inclined clockwise from the state shown in FIG. 10A, an image signal for displaying an inclined image for forming a projection screen including an image of a display screen, which is inclined clockwise by an angle substantially equal to the tilt angle α of the display surface 301a, is generated by a keystone correction process by the keystone corrector 419. Then, a projection screen based on the generated image signal is displayed on a screen. A projection screen to be formed by the keystone correction process is displayed in such a manner that the image of the display screen is displayed with a size smaller than the size of the projection screen and with a clockwise inclination, and that the outer region of the image of the display screen is formed of a predetermined background color.

As described above, in the case where the display surface 301a is inclined from a reference state, a projection screen itself which is projected onto a screen is not inclined, but an image of a display screen to be included in the projection screen is inclined in accordance with the inclination of the display surface 301a.

The display surface 301a is inclined with respect to a reference state in the in-plane direction of the display surface 301a substantially in the same manner as in the embodiment. Accordingly, as shown in FIGS. 10B and 10C, an image of a display screen on a screen is inclined in the in-plane direction of the screen.

Referring back to FIG. 9, while the output of a tilt signal from the mobile device 2 is continued (S304: NO), the controller 411 repeats the processes of Step S302 and Step S303 at a predetermined time interval. In the case where the output of a tilt signal from the mobile device 2 is stopped (S304: YES), the control process is ended.

As described above, in the modification, in response to user's operation of inclining the display surface 301a for an input operation, an image of a display screen on a screen is inclined in accordance with the inclination of the display surface 301a substantially in the same manner as in the embodiment. Accordingly, the modification is advantageous in providing the user with more realistic feeling, as compared with an arrangement that an image of a display screen is simply enlarged and projected onto a screen.

Further, in the modification, the user is allowed to incline an image of a display screen formed on a screen by applying a signal processing to an image signal from the mobile device 2, without rotating a projection screen on the screen. Thus, the modification does not require a mechanical arrangement configured to rotate the projection display unit 20. Accordingly, the above arrangement is advantageous in suppressing complication of the structure of the projector 1, and suppressing an increase in the size of the projector 1. Further, the user is allowed to incline an image of a display screen formed on a screen in accordance with an inclination of the display surface 301a of the mobile device 2 in multiple directions.

Further, in the modification, the user is allowed to utilize the keystone correction process. Accordingly, the modification is advantageous in easily implementing a signal processing for inclining an image of a display screen on a screen.

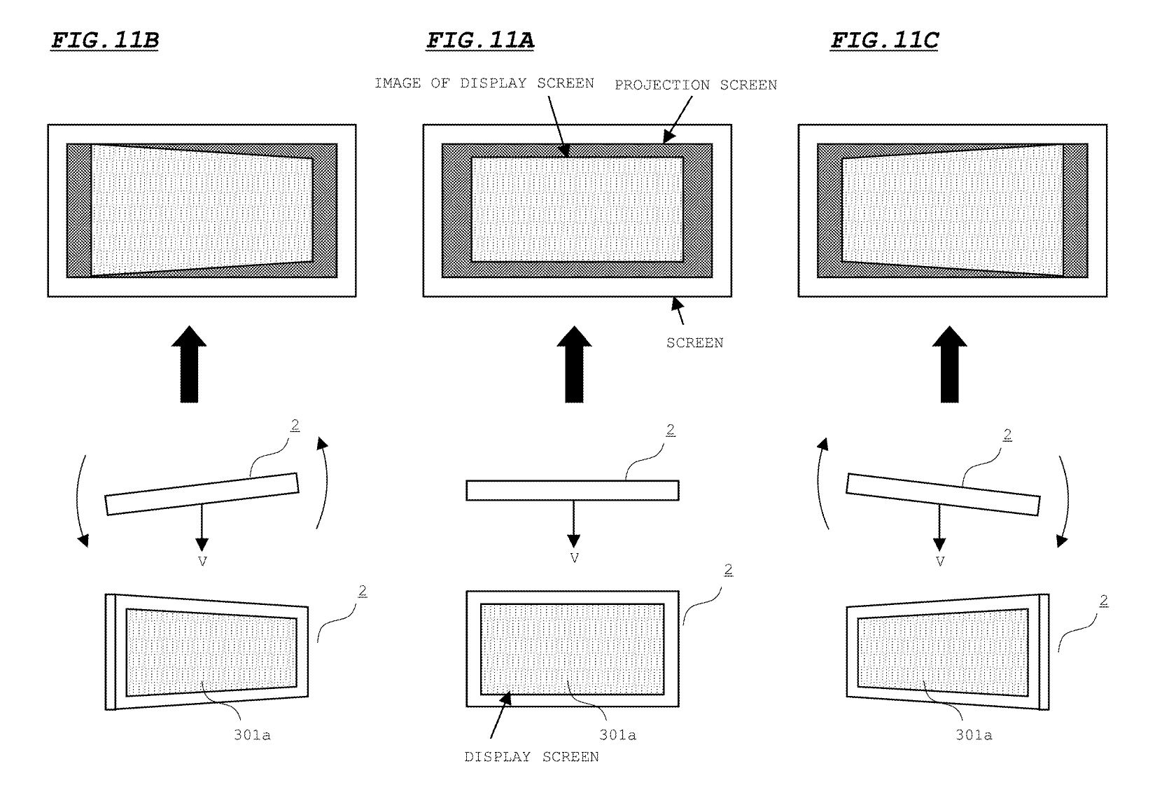

In the modification, a display screen on a screen is inclined in accordance with the tilt angle α of the display surface 301a in the in-plane direction of the display surface 301a, as shown in FIG. 1C. Alternatively, the projector may be configured to incline an image of a display screen on a screen in accordance with an inclination of the display surface 301a in a direction other than the above direction. For instance, as shown in FIGS. 11A through 11C, the projector may be configured to incline an image of a display screen on a screen in accordance with an inclination of the display surface 301a with respect to normal direction V. In the above modification, as shown in FIGS. 11B and 11C, an image of a display screen to be included in a projection screen is formed into a trapezoidal shape so that the user recognizes as if the image of the display screen to be included in the projection screen is inclined in the depth direction of the screen in accordance with an inclination of the display surface 301a.

### Others

The embodiment and the modifications of the invention have been described as above. The invention is not limited to the foregoing embodiment and modifications, and the embodiment of the invention may be modified in various ways other than the above.

For instance, in the embodiment, a projection screen is inclined by the arrangement configured to rotate the entirety of the projection display unit 20. In other words, the projection display unit 20 corresponds to an image generating part in the invention. The invention is not limited to the above. For instance, a projection lens unit 203 in a projection display unit 20 may be fixedly mounted to a base unit 10, and a projection screen may be inclined by an arrangement configured to rotate a cabinet 201 and an optical engine 202. In the above modification, the cabinet 201 rotates about the optical axis L of the projection lens unit 203 as an axis of rotation. The cabinet 201 and the optical engine 202 constitute an image generating part in the invention.

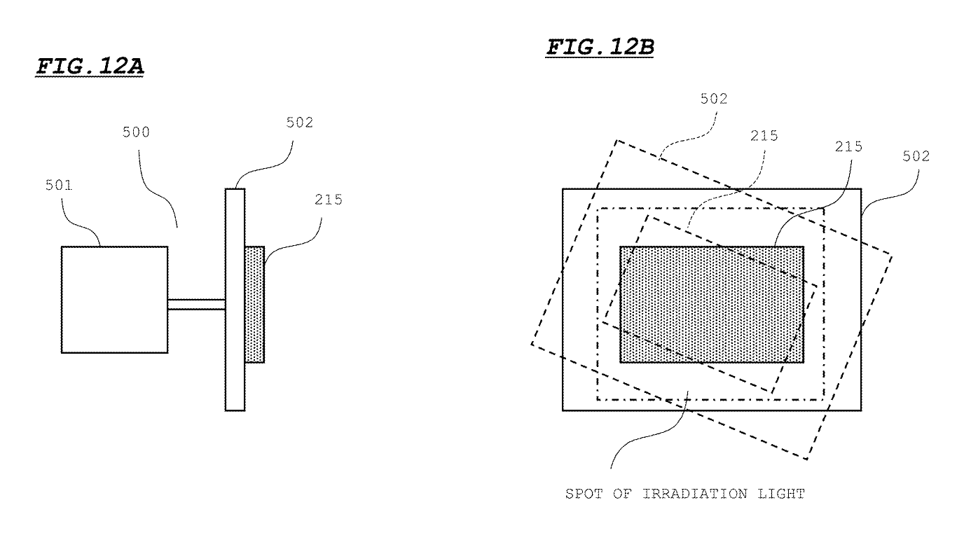

Further alternatively, a projection screen may be inclined by an arrangement configured to rotate an image modulator 215 constituting an optical engine 202, in place of rotating the entirety of the optical engine 202. FIGS. 12A and 12B are diagrams showing an example of an arrangement configured to rotate an image modulator 215. FIGS. 12A and 12B are respectively a side view and a front view of the image modulator 215 and an actuator 500. The actuator 500 is provided with a motor 501, and a fixing plate 502 configured to rotate by the motor 501. The image modulator 215 is fixedly mounted to the fixing plate 502. As shown in FIG. 12B, in the case where the fixing plate 502 rotates in response to rotation of the motor 501, the image modulator 215 is inclined. The spot size of light to be irradiated onto the image modulator 215 is set to such a size capable of radiating onto the entirety of the image modulator 215, even if the image modulator 215 is inclined up to an upper limit position. In this example, the image modulator 215 corresponds to an image generating part in the invention.

Further, in the embodiment, the tilt detector 233 is provided in the projection display unit 20, and the projection display unit 20 rotates by an angle substantially equal to the tilt angle α of the display surface 301a by causing the tilt detector 233 to detect an actual inclination of the projection display unit 20. Alternatively, a rotation amount of the motor 102 for rotating the projection display unit 20 by an angle substantially equal to the tilt angle α of the display surface 301a maybe determined in advance by e.g. an experiment, without providing the tilt detector 233 in the projection display unit 20, the rotation amount maybe stored in the first storage 222, and the first controller 221 may cause the motor 102 to rotate by the rotation amount corresponding to the tilt angle α.

Further, in the embodiment, the optical engine 202 is configured to generate image light by an optical system incorporated with a single reflective liquid crystal panel. Alternatively, an optical engine maybe configured to generate image light by an optical system incorporated with three reflective liquid crystal panels. Further alternatively, the optical engine 202 may be constituted of an optical system incorporated with e.g. a transmissive liquid crystal panel or a DMD (Digital Micromirror Device) as an imager. Further alternatively, the light source part 211 may be constituted of a lamp light source or a laser light source, in place of an LED light source.

Further, in the embodiment, a small-sized projector is exemplified. Alternatively, the invention may be applied to a large-sized projector other than such a small-sized projector.

Further, the invention is applicable to various image display devices other than projectors. For instance, the invention is applicable to monitor displays such as liquid crystal displays and organic EL displays, and to televisions such as liquid crystal televisions and organic EL televisions. Further, the invention is applicable to display systems for game machines equipped in e.g. game arcades, and to display systems for use in simulation, which are used in e.g. practice of driving a vehicle.

In the following, another embodiment in which the inventive image display device is applied to a liquid crystal display is described.

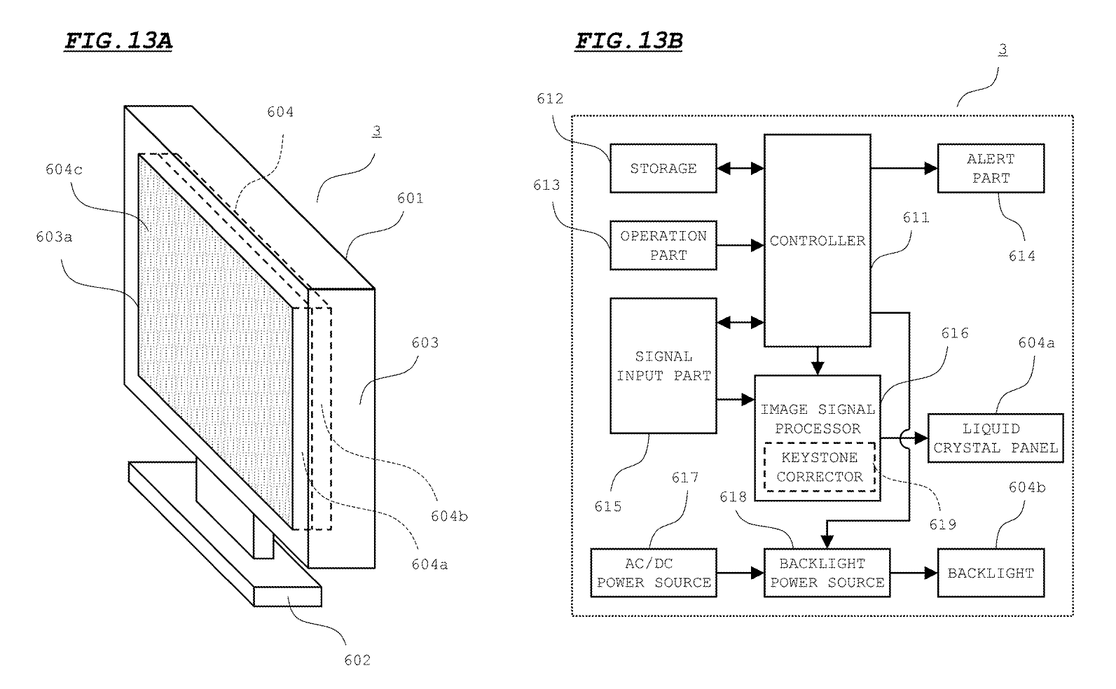

FIGS. 13A and 13B are diagrams showing an arrangement of a liquid crystal display 3 according to another embodiment. FIG. 13A is a perspective view of the liquid crystal display 3, and FIG. 13B is a block diagram of the liquid crystal display 3.

In the liquid crystal display 3 according to another embodiment, an image of a display screen of a mobile device 2, which is displayed on a display surface 604c of the liquid crystal display 3, is inclined in accordance with an inclination of a display surface 301a of the mobile device 2 by applying a signal processing to an image signal from the mobile device 2 in the same manner as in the projector 1 of the modification. Preferably, the liquid crystal display 3 is a large liquid crystal display.

As shown in FIG. 13A, the liquid crystal display 3 is constituted of a display main body 601, and a stand member 602 configured to support the display main body 601. The display main body 601 is provided with a housing 603, and a panel unit 604 disposed in the housing 603. The housing 603 and the panel unit 604 each has a substantially rectangular parallelepiped shape with flat front and rear surfaces and a long size in a transverse direction. The panel unit 604 includes a liquid crystal panel 604a, and a backlight 604b configured to illuminate the liquid crystal panel 604a. The display surface 604c of the panel unit 604 is exposed to the exterior through a display window 603a of the housing 603.

As shown in FIG. 13B, the liquid crystal display 3 is further provided with a controller 611, a storage 612, an operation part 613, an alert part 614, a signal input part 615, an image signal processor 616, an AC/DC power source 617, and a backlight power source 618.

The operation part 613 is provided with various operation keys relating to operations of the liquid crystal display 3. The operation part 613 outputs an operation signal indicating a user's key operation to the controller 611. The alert part 614 alerts the user of e.g. various errors.

The signal input part 615 acquires an image signal and a tilt signal outputted from the mobile device 2, and outputs the acquired image signal and the acquired tilt signal to the image signal processor 616. In the case where an image signal and a tilt signal are transmitted/received by wire, the signal input part 615 is configured to include an input terminal for inputting the image signal, and an input terminal for inputting the tilt signal. On the other hand, in the case where an image signal and a tilt signal are transmitted/received wirelessly, the signal input part 615 is configured to include a receiving circuit for receiving the image signal and the tilt signal as wireless signals.

The image signal processor 616 applies various processes to an image signal inputted from the signal input part 615 in accordance with a control signal from the controller 611 for generating an image signal suitable for the liquid crystal panel 604a, and outputs the generated image signal to the liquid crystal panel 604a. For instance, in response to input of an image signal relating to a display screen to be displayed on the display surface 301a of the mobile device 2, the image signal processor 616 generates an image signal for forming, on the display surface 604c of the liquid crystal panel 604a, a display screen including a display screen of the mobile device 2. The liquid crystal panel 604a modulates light from the backlight 604b in accordance with the image signal from the image signal processor 616, whereby an image (display screen) corresponding to the image signal is formed on the display surface 604c.

The storage 612 is constituted of an RAM, an ROM, and the like. The storage 612 stores a control program for causing the controller 611 to exhibit a certain control function.

The controller 611 is provided with a CPU. The controller 611 controls the image signal processor 616, the liquid crystal panel 604a, and the backlight power source 618 in accordance with a control program stored in the storage 612, based on e.g. an operation signal from the operation part 613.

The AC/DC power source 617 converts AC electric power supplied from a commercial power source into DC electric power for supplying the DC electric power to the backlight power source 618. The backlight power source 618 generates electric power suitable for driving the backlight 604b, out of the electric power supplied from the AC/DC power source 617. The backlight power source 618 drives the backlight 604b by supplying the generated electric power to the backlight 604b in accordance with a control signal from the controller 611.

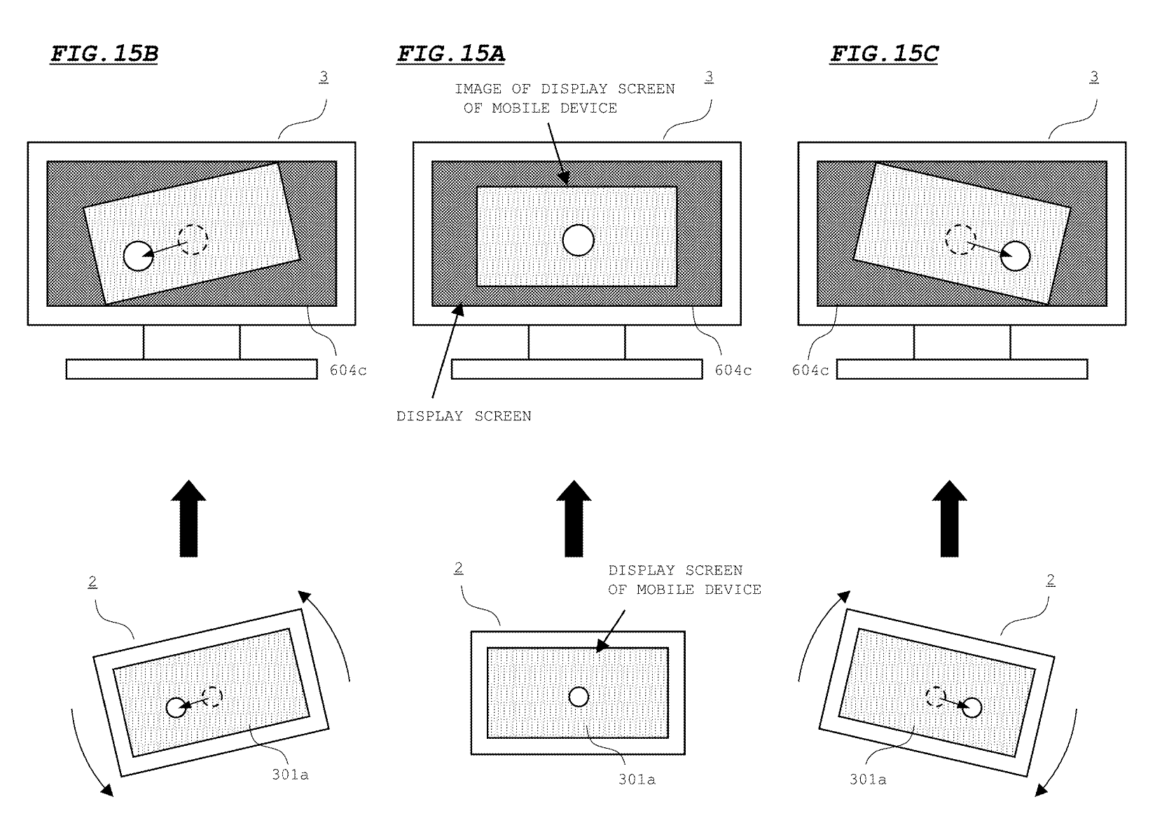

The image signal processor 616 is provided with a keystone corrector 619. The keystone corrector 619 receives, from the signal input part 615, an image signal and a tilt signal derived from the mobile device 2. The keystone corrector 619 performs a keystone correction process to the image signal derived from the mobile device 2 for generating an image signal for displaying an inclined image. Light from the backlight 604b is modulated by the liquid crystal panel 604a in accordance with the image signal for displaying an inclined image, whereby a display screen, in which an image of a display screen displayed on the display surface 301a is inclined, is displayed on the display surface 604c in accordance with a tilt angle α of the display surface 301a of the mobile device 2 (see FIGS. 15B and 15C).

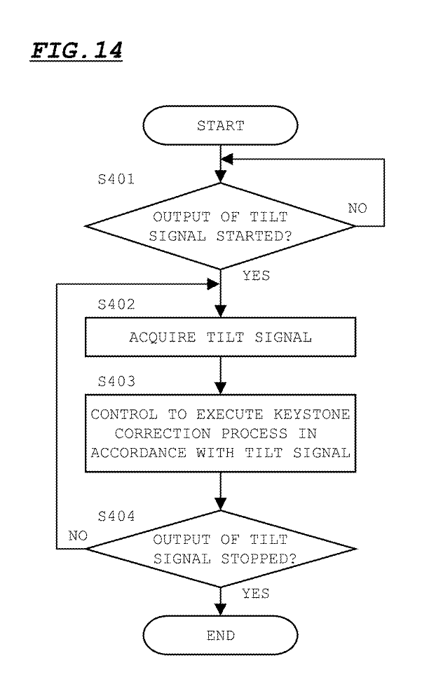

FIG. 14 is a flowchart showing a control process for inclining an image of a display screen of the mobile device 2, which is displayed on the display surface 604c of the liquid crystal display 3, in accordance with an inclination of the display surface 301a of the mobile device 2 according to another embodiment. FIGS. 15A through 15C are diagrams each showing a movement of an image of a display screen on the display surface 604c of the liquid crystal display 3, in the case where the user inclines the display surface 301a of the mobile device 2 when the image of the display screen of the mobile device 2 is displayed on the display surface 604c of the liquid crystal display 3 according to another embodiment.

A control process for transmitting a tilt signal from the mobile device 2 is substantially the same as the control process of the embodiment described referring to FIG. 6A.

Referring to FIG. 14, in the liquid crystal display 3, in the case where output of a tilt signal from the mobile device 2 is started (S401: YES), the controller 611 acquires the tilt signal from the mobile device 2 (S402). Then, the controller 611 provides the image signal processor 616 with an instruction to execute a keystone correction process in accordance with the tilt signal (S403).

AS shown in FIG. 15A, in the case where the display surface 301a is in a reference state, an image signal for displaying an inclined image so as to form, on the display surface 604c, a display screen including an image of a display screen of the mobile device 2 in a horizontal state is generated by a keystone correction process by the keystone corrector 619. Then, a display screen based on the generated image signal is displayed on the display surface 604c. The display screen on the display surface 604c to be formed by the keystone correction process is displayed in such a manner that the image of the display screen of the mobile device 2 is displayed with a size smaller than the size of the display screen on the display surface 604c, and that the outer region of the image of the display screen of the mobile device 2 is formed of a predetermined background color (e.g. black).

As shown in FIG. 15B, in the case where the display surface 301a is inclined counterclockwise from the state shown in FIG. 15A, an image signal for displaying an inclined image so as to form, on the display surface 604c, a display screen including an image of a display screen, which is inclined counterclockwise by an angle substantially equal to the tilt angle α of the display surface 301a of the mobile device 2, is generated by a keystone correction process by the keystone corrector 619. Then, a display screen based on the generated image signal is displayed on the display surface 604c. A display screen on the display surface 604c to be formed by the keystone correction process is displayed in such a manner that the image of the display screen of the mobile device 2 is displayed with a size smaller than the size of the display screen on the display surface 604c and with a counterclockwise inclination, and that the outer region of the image of the display screen of the mobile device 2 is formed of a predetermined background color.

On the other hand, as shown in FIG. 15C, in the case where the display surface 301a is inclined clockwise from the state shown in FIG. 15A, an image signal for displaying an inclined image so as to form, on the display surface 604c, a display screen including an image of a display screen, which is inclined clockwise by an angle substantially equal to the tilt angle α of the display surface 301a of the mobile device 2, is generated by a keystone correction process by the keystone corrector 619. Then, a display screen based on the generated image signal is displayed on the display surface 604c. A display screen on the display surface 604c to be formed by the keystone correction process is displayed in such a manner that the image of the display screen of the mobile device 2 is displayed with a size smaller than the size of the display screen on the display surface 604c and with a clockwise inclination, and that the outer region of the image of the display screen of the mobile device 2 is formed of a predetermined background color.

As described above, in the case where the display surface 301a of the mobile device 2 is inclined from a reference state, a display screen itself which is displayed on the display surface 604c of the liquid crystal display 3 is not inclined, but an image of a display screen of the mobile device 2 to be included in the display screen is inclined in accordance with an inclination of the display surface 301a.

The display surface 301a is inclined with respect to a reference state in the in-plane direction of the display surface 301a substantially in the same manner as in the embodiment. Accordingly, as shown in FIGS. 15B and 15C, an image of a display screen on the display surface 604c of the liquid crystal display 3 is inclined in the in-plane direction of the display surface 604c.

Referring back to FIG. 14, while the output of a tilt signal from the mobile device 2 is continued (S404: NO), the controller 611 repeats the processes of Step S402 and Step S403 at a predetermined time interval. In the case where the output of a tilt signal from the mobile device 2 is stopped (S404: YES), the control process is ended.

As described above, the liquid crystal display 3 according to another embodiment is advantageous in providing the user with more realistic feeling, as compared with an arrangement that an image of a display screen of the mobile device 2 is simply enlarged and displayed on the display surface 604c of the liquid crystal display 3.

Further, in the liquid crystal display 3 according to another embodiment, the user is allowed to incline an image of a display screen of the mobile device 2 displayed on the display surface 604c by applying a signal processing to an image signal from the mobile device 2. Thus, another embodiment does not require a mechanical arrangement. Accordingly, the above arrangement is advantageous in suppressing complication of the structure of the liquid crystal display 3, and suppressing an increase in the size of the liquid crystal display 3. Further, the user is allowed to incline an image of a display screen of the mobile device 2 displayed on the display surface 604c in accordance with an inclination of the display surface 301a of the mobile device 2 in multiple directions.

Further, in the liquid crystal display 3 according to another embodiment, the user is allowed to utilize the keystone correction process. Accordingly, the above arrangement is advantageous in easily implementing a signal processing for inclining an image of a display screen of the mobile device 2 displayed on the display surface 604c.

Alternatively, the liquid crystal display 3 according to another embodiment may also be configured to incline an image of a display screen of the mobile device 2 on the display surface 604c in accordance with an inclination of the display surface 301a with respect to normal direction V substantially in the same manner as the arrangement of the modification shown in FIGS. 11A through 11C. In the above modification, an image of a display screen of the mobile device 2 to be included in a display screen on the display surface 604c of the liquid crystal display 3 is formed into a trapezoidal shape so that the user recognizes as if the image of the display screen of the mobile device 2 to be included in the display screen on the display surface 604c of the liquid crystal display 3 is inclined in the depth direction of the display surface 604c in accordance with an inclination of the display surface 301a of the mobile device 2 substantially in the same manner as in the arrangement shown in FIGS. 11A through 11C.

The embodiments of the invention may be changed or modified in various ways as necessary, as far as such changes and modifications do not depart from the scope of the claims of the invention hereinafter defined.

What is claimed is:

1. An image display device, comprising:
an image generating part which generates an image to be displayed on a predetermined image display surface;
a circuit part which operates the image generating part based on an image signal;
an image acquiring part which acquires an image signal to be outputted from a mobile device for supplying the image signal to the circuit part;
a tilt acquiring part which acquires, from the mobile device, a tilt signal indicating a tilt angle of a display surface of the mobile device with respect to a reference state; and
screen state changing part which changes a state of a screen to be displayed on the image display surface in accordance with the tilt signal, wherein
the screen state changing part inclines, on the image display surface, an image based on the image signal acquired by the image acquiring part, based on the tilt signal in accordance with the inclination of the display surface.

2. The image display device according to claim 1, wherein
the image generating part includes an image modulator which modulates light from a light source for generating image light,
the image display device further comprises a projection part which projects the image light onto a projection plane as the image display surface, and
the screen state changing part includes:
a driver which rotates the image generating part in such a manner that a projection screen to be formed by the image light rotates on the projection plane, and
a drive controller which controls the driver in accordance with the tile signal.

3. The image display device according to claim 2, wherein
the reference state is a state that a transverse direction of the display surface is in parallel to a horizontal plane,
the tilt signal indicates a tilt angle of the display surface with respect to the reference state in an in-plane direction of the display surface,
the driver rotates the image generating part in an in-plane direction perpendicular to an emission direction of the image light from the image generating part, and
the driving controller controls the driver in accordance with the tilt signal in such a manner that a transverse direction of the projection screen is inclined with respect to the horizontal plane in a same direction as the display surface.

4. The image display device according to claim 3, wherein
the driver rotates the image generating part about a center axis of the image light as an axis of rotation.

5. The image display device according to claim 1, wherein
the screen state changing part includes a signal processor which is disposed in the circuit part and processes the image signal acquired by the image acquiring part in accordance with the tilt signal, and
the signal processor generates a signal for displaying an inclined image so as to form the screen out of the image signal acquired by the image acquiring part, the screen being such that an image based on the image signal is inclined on the image display surface.

6. The image display device according to claim 5, wherein
the signal processor generates the signal for displaying an inclined image by performing a keystone correction process in accordance with the tilt signal.

7. A mobile device, comprising:
a display part which is configured to display, on a display surface, a screen based on an image signal;
an image supplying part which supplies, to an external device, the image signal for forming the screen to be displayed on the display surface; and
a tilt supplying part which supplies, to the external device, a tilt signal indicating an inclination of the display surface with respect to a reference state concurrently with supply of the image signal.

8. The mobile device according to claim 7, wherein the reference state is a state that a transverse direction of the display surface is in parallel to a horizontal plane, and
the tilt signal is a signal indicating an inclination of the display surface with respect to the reference state in an in-plane direction of the display surface.
